(19) United States
(12) Patent Application Publication
(10) Pub. No.: US 2023/0137701 A1
(43) Pub. Date: May 4, 2023

(54) BEVERAGE PREPARATION DEVICE WITH COOLED ADDITIVE CONTAINERS

(71) Applicant: SOCIETE DES PRODUITS NESTLE S.A., Vevey (CH)

(72) Inventors: JEAN HINSCHBERGER, Vittel (FR); FRANCOIS PREVOTAT, Verrieres le Buisson (FR)

(21) Appl. No.: 17/907,702

(22) PCT Filed: Mar. 29, 2021
(86) PCT No.: PCT/EP2021/058088

§ 371 Date: Sep. 29, 2022

(30) Foreign Application Priority Data
Mar. 30, 2020 (EP) 20166627.8

(51) Int. Cl. B67D 1/00; B67D 1/08

(52) U.S. Cl. CPC B67D 1/0021; B67D 1/0858; B67D 1/0884; B67D 2210/00118

(57) ABSTRACT

The present invention relates to a beverage preparation device (1) comprising a beverage preparation section (2) for preparing and dispensing a beverage product, a water supply (4) for supplying water to the beverage preparation section (2) for beverage preparation, and an additive supply (6) for supplying beverage additives to the beverage preparation section (2) to be mixed with water from the water supply (4) for beverage preparation. The additive supply (6) comprises a storage section (10) for housing and storing containers (12) respectively carrying a beverage additive. The additive supply (6) comprises a cooling device (16) for cooling the containers (12) stored in the storage section (10).

### FIELD OF THE INVENTION

The present invention relates to a beverage preparation device, which can be integrated for example in a stand-alone drink dispensing or vending machine. The present invention may be used to prepare a wide spectrum of beverages. Such beverages are usually composed of water and at least one beverage additive like flavor or aroma, etc.

### TECHNICAL BACKGROUND

In order to prepare and dispense such beverages, some of the known beverage preparation devices may comprise a beverage preparation section, a water supply, and an additive supply for supplying beverage additive(s) to be mixed with water from the water supply in the beverage preparation section.

However, the present applicant has observed that the known beverage preparation devices present the following problems and drawbacks. The additive supply must usually contain preservatives to prevent the beverage additive(s) from decaying and thus keep the beverage additive(s) safe and tasty all along their storage in the beverage preparation device.

It can nevertheless be desirable to prepare beverages with beverage additive(s) having little or no preservatives. But such beverage additive(s) have too short a shelf-life to be used in the known beverage preparation devices, as such beverage additive(s) would require too frequent replacements, typically every 3 or 4 days, and thus risk producing much waste.

### SUMMARY OF THE INVENTION

In view of the above-mentioned problems and drawbacks, the present invention aims to improve the current implementations. An objective is to provide a beverage preparation device that may prepare beverages with beverage additive(s) having little or no preservatives. The objective is achieved by the subject-matter defined in the independent claims. Advantageous implementations are further defined in the dependent claims.

An embodiment of the invention provides a beverage preparation device comprising:
a beverage preparation section for preparing and dispensing a beverage,
a water supply for supplying water to the beverage preparation section for beverage preparation,
an additive supply for supplying beverage additives to the beverage preparation section to be mixed with water from the water supply for beverage preparation,
   wherein the additive supply comprises a storage section for storing containers respectively carrying a beverage additive, and
   wherein the additive supply comprises a cooling device for cooling the containers stored in the storage section.

Thus, the cooling device makes it possible to extend the shelf-life of the beverage additive to e.g. a few weeks by maintaining a low and constant temperature in the beverage additive. So the beverage preparation device may be loaded with containers carrying beverage additive(s) having little or no preservatives. With the present invention a ready-to-drink beverage may be prepared in a safe and hygienic manner.

Besides, the energy consumption of the cooling device can be small since the cooling device is part of the additive supply, which has the storage section housing the containers.

In some implementations, the water supply may be fluidly connected to a water distribution network (tap water). Alternatively, the water supply may be fluidly connected to a water container located in or near the beverage preparation device containing for example, spring water, mineral water or drinking water.

In the proposed implementations, the water can be supplied as still water or carbonated water (sparkling water), preferably with a choice of different carbonation levels.

The water may also be dispensed at different temperature according to the user selection. The water may be selected cool, at room temperature or heated.

In various implementations, the cooling device may be a refrigerator encasing the storage section.

Thus, the refrigerator may cool down the storage section, hence also the containers stored therein and the beverage additives contained in these containers. As the refrigerator dimensions may be adapted to the storage section, the energy consumption of the refrigerator can be minimized, i.e. set to the minimum necessary to cool down the beverage additives.

In some implementations, the refrigerator may have a parallelepiped shape.

In a possible complementary implementation, the piping and pumps associated with the supply of the beverage additive(s) to the beverage preparation section may also be located within the refrigerator.

In various implementations, the cooling device may comprise a door for accessing the storage section and in particular the containers stored therein.

Thus, the door may enable an operator to quickly unload and load, hence replace, the containers stored in the storing section of the cooling device.

In various implementations, the cooling device may comprise spacers, preferably insulated, like ridges, to support the containers within the storage section distant from a cold portion of the cooling device.

Thus, the spacers may prevent a beverage additive from freezing since the spacers keep the containers distant from the cold portion, for example an inner wall of a refrigerator, which would be at a temperature below 0° C.

Preferably, the spacers may be made of insulating material.

In various implementations, the beverage preparation device may further comprise a heat dissipating element for dissipating heat out of the cooling device, wherein the heat dissipating element comprises a ventilation device and/or a heat conduction structure like a heat sink.

Thus, the heat dissipating element may help the cooling device efficiently cool down the storing section and/or controlling the temperature inside the beverage preparation device.

In various implementations, the additive supply may further comprise an additional storage section for storing additional containers respectively carrying an additional beverage additive at ambient temperature.

Thus, the additional storage section makes it possible for the beverage preparation device to add ingredients in the prepared beverage beside the beverage additives.

In various implementations, the containers and, if any, the additional containers may be bag-in-boxes.

Thus, the bag-in-boxes may enable an operator to conveniently and quickly unload and load the containers, while preserving their content.

Alternatively, the containers may be a packaging of the Tetra Pak© type or equivalent. Alternatively, the containers may be made of any kind of material, structure and shape compatible with the intended use.

In various implementations, at least one beverage additive carried by the containers in the storage section may be selected in the group consisting of flavors, aromas, minerals, mineral solution, mineral liquid concentrate, oligo elements vitamins, vitamins premix, coffee extract for example caffeine, tea extract, plant or vegetable extract or component, fruit juice, fibers, probiotics, prebiotics, prophylactics ingredients, and preferably said at least one beverage additive may have less than 0.03% of preservatives, more preferably no preservative.

Thus, the beverage additive may be a flavor or an aroma, preferably natural and preferably without colorant, for example orange, peach, lemon, etc. or a mix of flavor or aroma, for example, pineapple-ginger, mint-cucumber, etc. The beverage additive may be a tea extract or a coffee extract, a fruit juice or extract, a mineral solution, a mineral liquid concentrate or a premix of minerals, or any so-called “functional concentrate” or “functional enhancer”, which produces an effect on the consumer, in particular an effect different from an organoleptic effect. For example, the beverage additive may be a probiotic, a prophylactic, a vitamin, proteins, fibers, caffeine or another coffee or tea extract.

Preferably, the beverage additive may be in the form of concentrated solutions.

In a complementary implementation, the beverage additive may be a premix of one or more beverage additive, for example a mix of flavor or a mix of minerals.

Preferably, at least one of the beverage additives carried by the containers may have less than 0.03% preservatives. More preferably, at least one of the beverage additives carried by the containers contains no preservative.

In various implementations, the storage section may be designed to receive the containers in a tilted orientation to facilitate dispensing of the beverage additives respectively carried by the containers, and preferably the additional storage section may also be designed to receive the additional containers in a tilted orientation to facilitate dispensing of the additional beverage additives respectively carried by the additional containers.

More particularly, the container tilting orientation shall be directed to have the connection device at the lowest point of the container to facilitate dispensing and allow the container to be emptied with no remaining product inside.

Thus, most or all of the beverage additives or of the additional beverage additives may be dispensed in the prepared beverages, which reduces waste. The tilted orientation of the containers and the tilted orientation of the additional containers is measurable with respect to a horizontal direction when the beverage preparation device is in service on a horizontal surface.

In various implementations, the cooling device, preferably the refrigerator, may be tilted and/or wherein the storage section may have a sloped part for carrying the containers in an inclined manner, the sloped part being preferably an inner bottom wall of the cooling device and/or the spacers.

Thus, most or all of the beverage additives or of the additional beverage additives may be dispensed in the prepared beverages, which reduces waste. The tilted orientation of the cooling device and/or of the sloped part is measurable with respect to a horizontal direction when the beverage preparation device is in service on a horizontal surface.

In various implementations, the water supply and the beverage preparation section may be fluidly connected by at least one water duct, and the additive supply and the beverage preparation section may be fluidly connected by at least one additive duct, the at least one additive duct being preferably thermally insulated and/or cooled down.

Thus, the thermal insulation of the at least one additive duct may minimize the energy consumption required to preserve the beverage additives by keeping those at low temperature.

In various embodiments, the water duct may comprise at least one pipe, tube, hose or channel. In various embodiments, the additive duct may comprise at least one pipe, tube, hose or channel.

In various embodiments, the additive supply may comprise at least one additive pump configured for supplying additive, preferably in a fluidic state, from a container to the beverage preparation section. In various embodiments, the additive pump may be a peristaltic pump configured to compress a respective additive duct.

In various implementations, the water supply may comprise a water cooling section for cooling water to be delivered to the beverage preparation section, the water cooling section may be a separate chiller or is part of the cooling device, the water cooling section preferably comprising a cooling loop being guided through the cooling device.

Thus, when the water cooling section is a separate chiller, the water cooling section may be cooled at a different temperature vis-à-vis the cooling device which cools the beverage additives. Besides, when the water cooling section is part of the cooling device, the required space and cost for the cooling components may be kept low and in particular minimized.

In various implementations, the beverage preparation section may comprise a mixing chamber for preparing a beverage by mixing the water supplied by the water supply and, if any, a beverage additive supplied by the additive supply, and/or, if any, an additional beverage additive supplied by the additive supply, and/or the beverage preparation section may comprise a dispensing outlet for dispensing the beverage product, preferably out of the mixing chamber.

Thus, the mixing chamber may mix the beverage components, for example water and beverage additives, before dispensing the beverage. Besides, the dispensing outlet may dispense the prepared beverage in a user's cup or glass.

In various implementations, the beverage preparation device may further comprise a control unit for controlling a beverage preparation, preferably upon a user's selection, and/or for controlling a temperature of the cooling device and/or of a container to be cooled, and/or and a sensor may be configured to detect a temperature in the cooling device and/or a temperature of a container to be cooled, wherein the control unit may preferably be configured to prevent or stop the beverage preparation with the beverage additives if the detected temperature is equal to or exceeds a threshold value, preferably until the temperature drops below the threshold value and/or said container is replaced.

Thus, the control unit may control the operation of the beverage preparation device and in particular the composition of a beverage to be prepared in accordance with a user's selection. Besides, the sensor may avoid preparing a beverage with beverage additives that have not been suitably preserved.

In various embodiments, the threshold value may be 20 to 25° C. during a period of more than 4 to 6 consecutive hours

In various embodiments, even when the control unit prevents the beverage preparation with the unpreserved additives, the beverage preparation device may continue to dispense water or beverages prepared with the additional additives, which are not cooled by the cooling device.

In various implementations, the Beverage preparation device may further comprise a housing for housing the beverage preparation section, the water supply, and the additive supply.

Thus, the housing may compose a stand-alone drink dispensing machine, for example a stand-alone drink vending machine.

It has to be noted that all devices, elements, components, members, units and means described in the present application could be implemented in any technically applicable combination of the embodiments and implementations. All steps which are performed by the various entities described in the present application as well as the functionalities described to be performed by the various entities are intended to mean that the respective entity is adapted to or configured to perform the respective steps and functionalities. Even if, in the following description of specific embodiments, a specific functionality or step to be performed by external entities is not reflected in the description of a specific detailed element of that entity which performs that specific step or functionality, it should be clear for a skilled person that these methods and functionalities can be implemented in any technically applicable combination of the embodiments and implementations.

### BRIEF DESCRIPTION OF DRAWINGS

The above described aspects and implementation forms of the present invention will be explained in the following description of specific embodiments and aspects in relation to the enclosed drawings, in which:

FIG. 1 is a schematic exploded perspective view illustrating a beverage preparation device according to an embodiment of the present invention;

FIG. 2 is a schematic perspective view on a larger scale of detail I. in FIG. 1,

FIG. 3 is a schematic perspective view on a larger scale of detail II. in FIG. 1;

FIG. 4 is a schematic perspective view on a larger scale of detail Ill. in FIG. 1; and

FIG. 5 is a schematic perspective rearview on a larger scale of a part of the beverage preparation device of FIG. 1 in a partly assembled state.

### DETAILED DESCRIPTION

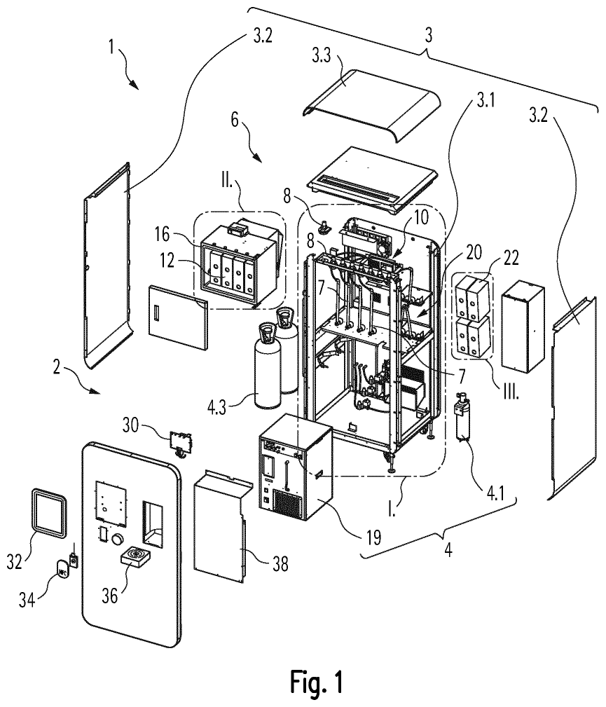

FIGS. 1, 2, 3, 4 and 5 illustrate a beverage preparation device 1 comprising a beverage preparation section 2, a water supply 4 and an additive supply 6. The beverage preparation device 1 may further comprise a housing 3 for housing the beverage preparation section 2, the water supply 4, and the additive supply 6. The housing 3 may comprise a frame 3.1, side walls 3.2, and a top wall 3.3 fastened to the frame 3.1.

The beverage preparation section 2 is configured to prepare and dispense a beverage product. The water supply 4 is configured to supply water to the beverage preparation section 2 for the preparation of a beverage. The water supply 4 and the beverage preparation section 2 may be fluidly connected by a water duct. The water duct may comprise at least one pipe, tube, hose or channel.

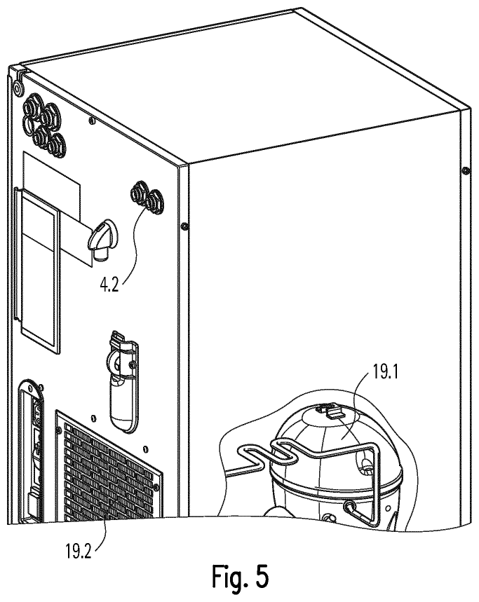

The water supply 4 may comprise a water pump configured for supplying water to the beverage preparation section 2. The water supply 4 may further comprise a water filter 4.1 for filtering the water, for example between the water pump and the beverage preparation section 2. Besides, the water supply 4 may have an inlet port 4.2, as illustrated in FIG. 4, which may be fluidly connected to a non-illustrated water distribution network.

The additive supply 6 is configured to supply beverage additives to the beverage preparation section 2. The beverage additives may be mixed with water from the water supply 4 for preparing a beverage. The additive supply 6 and the beverage preparation section 2 may be fluidly connected by one or more additive duct(s) 7. The additive ducts 7 may comprise at least one pipe, tube, hose or channel.

The additive supply 6 may comprise additive pumps 8 configured for supplying the beverage additives, preferably in a fluidic state, to the beverage preparation section 2. Each additive pump 8 may be a peristaltic pump configured to compress a respective additive duct 7, which is a compressible hose in this variant. In the example of FIG. 1, the additive supply 6 comprises four additive pumps 8, the left one of which is elevated to illustrate a dismounted state.

The additive supply 6 comprises a storage section 10 for storing four containers 12. The containers 12 may be bag-in-boxes. In an assembled state, the containers 12 may be located in the storage section 10 between the additive ducts 7 and the side wall 3.2 that is arranged at the rear of the beverage preparation device 1.

Each one of the containers 12 carries a respective beverage additive, which may be different or similar with respect to the beverage additives carried by the other containers. The beverage additives carried by the containers 12 in the storage section may be selected in the group consisting of flavors, aromas, minerals, mineral solution, mineral liquid concentrate, vitamins, and coffee extract for example caffeine, tea extract, fruit juice, probiotics, prophylactics. At least one the beverage additives carried by the containers 12 may contain no preservative or less than 0.03% of preservative.

The additive supply 6 further comprises a cooling device 16 for cooling the containers 12 stored in the storage section 10. Thus, the cooling device makes it possible to extend the shelf-life of the beverage additive to e.g. a few weeks by maintaining a low and constant temperature in the beverage additive. In the example of FIG. 1-5, the cooling device 16 may be a refrigerator configured to encase the storage section 10. The cooling device 16 aims at keeping the containers 12 stored in the storage section 10 within a given range of temperature, for example between 3 to 10° C.

In a variant, the additive ducts 7 and pumps 8 associated with the additive supply 6 may also be located within cooling device 16 and/or the refrigerator.

The design of the storage section allows preventing freezing of the stored containers 12 and ensuring a homogenous cooling of the containers 12.

The cooling device 16 may have walls arranged to define a parallelepiped shape. The walls of the cooling device 16 may preferably be thermally insulated vis-à-vis the exterior of the cooling device 16. Further, the one or each additive duct 7 may be thermally insulated on all or part of their extension connecting the additive supply 6 to the beverage preparation section 2 or it can in a possible embodiment be cooled down.

The cooling device 16 may further comprise a door 17 configured to allow an operator to access the storage section 10 and in particular the containers 12 that are stored in the storage section 10. When an operator needs to unload a container 12 and load a replacement container, the operator may open the door 17 and access the interior of the cooling device 16.

The cooling device 16 may also comprise non-illustrated spacers to support the containers 12 distant from the inner sides of the cold walls of the cooling device 16 so as to prevent a beverage additive from freezing inside a container 12. The spacers may be formed by ridges. The spacers may be made of insulating material.

The beverage preparation device 2 may further comprise a heat dissipating element 18 for dissipating heat out of the cooling device 16. The heat dissipating element 18 may comprise a non-illustrated ventilation device and/or a non-illustrated heat conduction structure, for example a heat sink or heat conducts.

The water supply 4 delivers water at ambient temperature (meaning at the temperature inside the beverage preparation device).

The water supply 4 may comprise a water cooling section 19, which is configured for cooling water to be delivered to the beverage preparation section 2. In the example of FIG. 1-5, the water cooling section 19 may include a separate chiller as in the example of FIG. 1. The water cooling section 19 may comprise a non-illustrated cooling loop guided through the cooling device 6. As illustrated in FIG. 4, the water cooling section 19 may further comprise a compressor 19.1 and a condenser 19.2 to handle a cooling medium.

The water supply 4 may comprise a water heating device (not represented), which is configured for heating water to be delivered to the beverage preparation section 2. The water heating device section may include a boiler.

The water supply 4 may supply still water and sparkling, carbonated water with different level of carbonation selectable. The water supply 4 may comprise one or more cylinders 4.3 containing CO2 for carbonating water.

Beside the storage section 10, the additive supply 6 may further comprise an additional storage section 20, which is configured to store additional containers 22. The additional containers 22 may be bag-in-boxes. Each one of the additional containers 22 respectively carries an additional beverage additive, which may be stored at ambient temperature.

The additional containers 22 may contain additional beverage additives that may be supplied for preparing a beverage in the beverage preparation section 2. The additive supply 6 may comprise four additional additive pumps configured for supplying the additional beverage additives, preferably in a fluidic state, to the beverage preparation section 2. Each additional additive pump may be a peristaltic pump similar to the additive pumps 8.

The additional beverage additives may for example be
minerals, for example Magnesium, Calcium or Potassium or any other mineral,
plant ingredient or extract, for example caffeine, green tea extract, taurine, etc., or
any other suitable ingredient

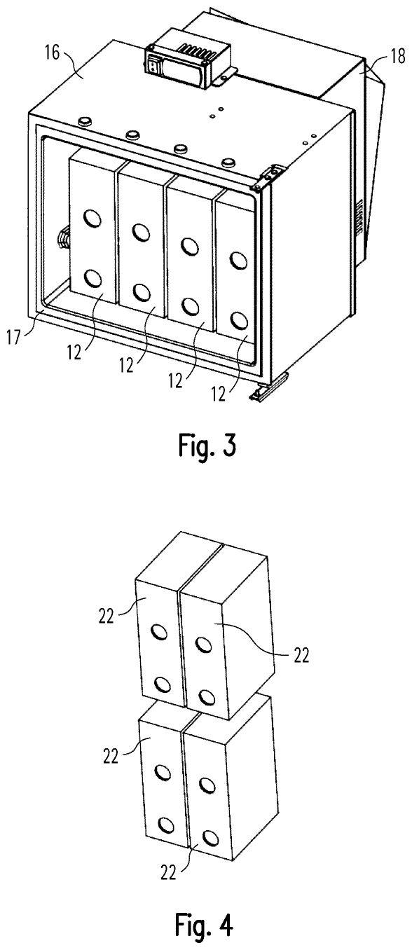

The storage section 10 may be designed to receive the containers 12 in a tilted orientation in order to facilitate the dispensing of the beverage additives respectively carried by the containers 12 as presented in FIG. 3. Likewise, the additional storage section 20 may be designed to receive the additional containers 22 in a tilted orientation in order to facilitate the dispensing of the additional beverage additives respectively carried by the additional containers 22 as presented in FIG. 4.

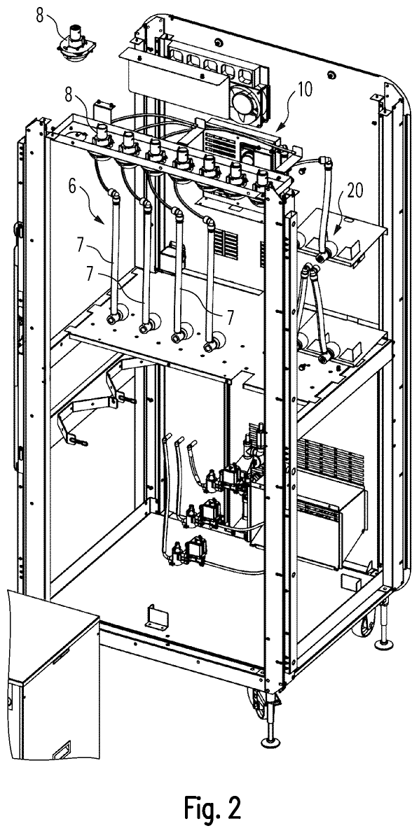

The cooling device 16 may be tilted and/or the storage section 10 may have a sloped part for carrying the containers in an inclined manner with respect to a horizontal direction when the beverage preparation device 1 is in service, but this is not visible on FIG. 1 or 2. The sloped part may for example be an inner bottom wall of the cooling device 16 and/or the non-illustrated spacers. Inclined containers 12 may be more completely emptied, in particular as their outlets are located near or at the bottom of the containers 12.

Likewise, the additional storage section 20 may be designed to receive the additional containers 22 in a tilted orientation in order to facilitate the dispensing of the additional beverage additives respectively carried by the additional containers 22.

The beverage preparation section 2 may comprise a non-illustrated mixing chamber, which may comprise a non-illustrated dispensing outlet for dispensing the beverage product. The beverage preparation section 2 may be configured for preparing a beverage by mixing:
i) the water supplied by the water supply 4,
ii) one or more beverage additive(s) supplied by the additive supply 6, and/or
iii) one or more additional beverage additive(s) supplied by the additive supply 6 from the additional storage section 20.

The beverage preparation device 1 may further comprise a control unit 30 configured for controlling the preparation of a beverage upon a user's selection. The beverage preparation device 1 may further comprise a display 32, a payment interface 34, a protection panel 38 behind the front wall, and a drip tray 36 configured for supporting the user's cup while the beverage preparation section 2 dispenses the prepared beverage.

The control unit 30 may convey information to the user via the display 32. The user may place an order for a beverage via the display 32, which may include a touchscreen, and pay via the payment interface 34. Then, the control unit 30 may control the beverage preparation section 2 to prepare and dispense the ordered beverage.

Additionally or alternatively, the control unit 30 may be configured for controlling a temperature of the cooling device 6 and/or of a container 12 to be cooled. The beverage preparation device 1 may further comprise a non-illustrated sensor is configured to detect a temperature in the cooling device 6 and/or a temperature of a container 12 to be cooled. The control unit 30 may be configured to prevent or stop the beverage preparation with the beverage additives if the temperature detected by the sensor is equal to or exceeds a threshold value, for example 20 to 25° C. during a period of more than 4 to 6 consecutive hours.

The control unit 30 may be configured to reauthorize the beverage preparation when the temperature drops below said threshold value and/or when said container 12 is replaced. Besides, even when the control unit 30 prevents the beverage preparation with the unpreserved beverage additives, the beverage preparation device 1 may continue to dispense water or beverages prepared with the additional beverage additives from the additional containers 22, which are not cooled by the cooling device 6.

The present invention has been described in conjunction with various embodiments and implementations as examples. However, other variations can be understood and effected by those persons skilled in the art and practicing the claimed invention, from the studies of the drawings, this disclosure and the independent claims. In the claims as well as in the description the word “comprising” does not exclude other elements or steps and the indefinite article “a” or “an” does not exclude a plurality. A single element or other unit may fulfill the functions of several entities or items recited in the claims.

1. Beverage preparation device comprising:
a beverage preparation section for preparing and dispensing a beverage,
a water supply for supplying water to the beverage preparation section for beverage preparation,
an additive supply for supplying beverage additives to the beverage preparation section to be mixed with water from the water supply for beverage preparation,
the additive supply comprises a storage section for storing containers respectively carrying a beverage additive, and
the additive supply comprises a cooling device for cooling the containers stored in the storage section.

2. Beverage preparation device according to claim 1, wherein the cooling device is a refrigerator encasing the storage section.

3. Beverage preparation device according to claim 1, wherein the cooling device comprises a door for accessing the storage section and in particular the containers stored therein.

4. Beverage preparation device according to claim 1, wherein the cooling device comprises spacers, like ridges, to support the containers within the storage section distant from a cold portion of the cooling device.

5. Beverage preparation device according to claim 1, further comprising a heat dissipating element for dissipating heat out of the cooling device, wherein the heat dissipating element comprises a ventilation device and/or a heat conduction structure like a heat sink.

6. Beverage preparation device according to claim 1, wherein the additive supply further comprises an additional storage section for storing additional containers respectively carrying an additional beverage additive at ambient temperature.

7. Beverage preparation device according to claim 1, wherein the containers and, if any, the additional containers are bag-in-boxes.

8. Beverage preparation device according to claim 1, wherein at least one beverage additive carried by the containers in the storage section is selected from the group consisting of flavors, aromas, minerals, mineral solution, mineral liquid concentrate, oligo elements, vitamins, coffee extract for example caffeine, tea extract, fruit juice, probiotics, and prophylactics.

9. Beverage preparation device according to claim 1, wherein the storage section is designed to receive the containers in a tilted orientation to facilitate dispensing of the beverage additives respectively carried by the containers.

10. Beverage preparation device according to claim 1, wherein the cooling device, is tilted and/or wherein the storage section has a sloped part for carrying the containers in an inclined manner, the sloped part being preferably an inner bottom wall of the cooling device and/or the spacers.

11. Beverage preparation device according to claim 1, wherein the water supply and the beverage preparation section are fluidly connected by at least one water duct, and
the additive supply and the beverage preparation section are fluidly connected by at least one additive duct, the at least one additive duct being preferably thermally insulated.

12. Beverage preparation device according to claim 1, wherein the water supply comprises a water cooling section for cooling water to be delivered to the beverage preparation section, and
wherein the water cooling section is a separate chiller or is part of the cooling device, the water cooling section preferably comprising a cooling loop being guided through the cooling device.

13. Beverage preparation device according to claim 1, wherein the beverage preparation section comprises a mixing chamber for preparing a beverage by mixing the water supplied by the water supply and, if any, a beverage additive supplied by the additive supply.

14. Beverage preparation device according to claim 1, further comprising a control unit for controlling a beverage preparation.

15. Beverage preparation device according to claim 1, further comprising a housing for housing the beverage preparation section, the water supply, and the additive supply.
